(19) United States
(12) Patent Application Publication
(10) Pub. No.: US 2025/0300720 A1
(43) Pub. Date: Sep. 25, 2025

(54) A DEVICE AND METHOD FOR IMPROVED ISOLATION OF COVERAGE ENHANCING DEVICES

(71) Applicant: Sony Group Corporation, Tokyo (JP)

(72) Inventors: Kun ZHAO, Malmö (SE); Fredrik RUSEK, Eslöv (SE); Zhinong YING, Lund (SE); Chaitanya TUMULA, Åkarp (SE); Olof ZANDER, Södra Sandby (SE); Jose FLORDELIS, Lund (SE); Erik BENGTSSON, Eslöv (SE)

(21) Appl. No.: 18/862,862

(22) PCT Filed: May 10, 2023
(86) PCT No.: PCT/EP2023/062415

§ 371 Date: Nov. 4, 2024

(30) Foreign Application Priority Data
May 18, 2022 (SE) 2250595-2

(51) Int. Cl. H04B 7/155; H04B 1/40

(52) U.S. Cl. CPC H04B 7/15571; H04B 1/40

(57) ABSTRACT

A coverage enhancing device is disclosed. The coverage enhancing device includes at least one antenna element. The coverage enhancing device includes a first antenna port associated with the at least one antenna element and configured to receive a first signal. The coverage enhancing device includes an amplifier in communication with the first antenna port, the amplifier configured to amplify the first signal for provision of a first amplified signal. The coverage enhancing device includes a second antenna port in communication with the amplifier, wherein the second antenna port is configured to transmit the first amplified signal. The second antenna port is a different antenna port than the first antenna port.

The present disclosure pertains to the field of wireless communications. The present disclosure relates to a method for improving isolation of coverage enhancing devices, and a related device.

### BACKGROUND

It can be advantageous to use a coverage enhancing device, such as having a reflective surface, with active gain for retransmitting signals. However, there are significant difficulties in achieving such active gain. As the reflected signal is amplified, it is far stronger than the received signal. The net effect of this amplification is that it may leak into the received signal, through electromagnetic coupling, and therefore an oscillating behavior may arise. The situation resembles that of full duplex where a similar situation has prohibited full duplex operation for several decades.

### SUMMARY

Accordingly, there is a need for coverage enhancing devices and methods for improving isolation of signals, which may mitigate, alleviate or address the shortcomings existing and may provide for retransmission of amplified signals with reduced and/or eliminated interference.

A coverage enhancing device is disclosed. The coverage enhancing device includes at least one antenna element. The coverage enhancing device includes a first antenna port associated with the at least one antenna element and configured to receive a first signal. The coverage enhancing device includes an amplifier in communication with the first antenna port, the amplifier configured to amplify the first signal for provision of a first amplified signal. The coverage enhancing device includes a second antenna port in communication with the amplifier. The second antenna port is configured to transmit the first amplified signal. The second antenna port is a different antenna port than the first antenna port. The first antenna port forms at least a part of a first antenna element of the at least one antenna element. The second antenna port forms at least a part of a second antenna element of the at least one antenna element.

A method of retransmitting a signal via a coverage enhancing device is disclosed. The method includes receiving, by a first antenna port associated with at least one antenna element, a first signal. The method includes amplifying, by an amplifier in communication with the first antenna port, the first signal for provision of a first amplified signal. The method includes transmitting, by a second antenna port in communication with the amplifier, the first amplified signal. The second antenna port is a different antenna port than the first antenna port.

It is an advantage of the present disclosure that the disclosed devices and methods may allow for improved isolation of amplified signals, in particular between received and transmitted signals, in a coverage enhancing device. This can advantageously reduce transient behaviors and avoid self-oscillation, caused by the leakage of amplified signals into a particular polarized receive port, thereby reducing interference that may occur in the coverage enhancing device and/or be caused by the coverage enhancing device.

It is a further advantage of the present disclosure to provide coverage enhancing devices, and related methods, which can support both rank 1 and rank 2 transmissions. While there may be uses for both ranks of transmissions, it can be particularly advantageous to be able to support either type of transmission.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example coverage enhancing device according to this disclosure,

FIG. 2 is a diagram illustrating an example coverage enhancing device according to this disclosure,

FIG. 3A is a diagram illustrating an example coverage enhancing device according to this disclosure,

FIGS. 3B-3C are gain graphs for an example coverage enhancing device of FIG. 3A,

FIGS. 4A-4C are diagrams illustrating an example coverage enhancing device according to this disclosure,

FIG. 5 is a diagram illustrating an example coverage enhancing device according to this disclosure,

FIG. 6 is a gain graph of an example coverage enhancing device according to this disclosure, and

FIGS. 7A-7B are a flow-chart illustrating an example method, performed in a coverage enhancing device, according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

Disclosed herein are coverage enhancing devices (CEDs) and methods allowing for improved signal isolation, which can reduce interference, such as caused by self-oscillation of amplified signals. Further, coverage enhancing devices and methods can be configured for both rank 1 and rank 2 transmissions.

For example, coverage enhancing devices of the disclosure can include hardware layout of an active-gain-CED that achieves sufficient isolation between received and reflected signals. Additionally, the coverage enhancing devices can support both rank-1 multiple-input and multiple-output (MIMO) transmission and rank-2 MIMO transmissions. As rank-1 transmissions can be superior in some situations, the disclosed coverage enhancing devices can be adaptive to support both rank 1 and rank 2 transmissions. In certain implementations, a coverage enhancing device can receive a signal from a network node which configures rank 1 and rank 2 transmission modes.

For example, a coverage enhancing device can be configured to add gain to a signal, such as by using an amplifier. A CED can be configured to receive a signal and retransmit it in another direction, and it can be advantageous to add gain during the retransmission. However, oscillation problems may occur, in particular self-oscillation and transient behaviour leading to interference, such as self-interference, due to leakage of the amplified signal from the transmit port back to the receive port. To avoid this, the disclosed coverage enhancing devices can have isolation from input and output. While this may be done with a circulator, the circulator may also require the use of filters, or may require a physically large component. Further, a circulator has limited isolation e.g., 15 dB.

The disclosed coverage enhancing devices can utilize different antenna ports, such as a first antenna port and/or a second antenna port, to achieve better isolation. For example, the CED can be an antenna array composed of many different antenna elements. Each of the antenna elements can have different antenna ports, such as a first antenna port and a second antenna port. The different ports can have different polarizations, for example linear or circular, to increase isolation. A combination of the different ports with different polarizations, as well as optionally receiving and transmitting from different antenna elements, can improve isolation.

As these antenna elements are resonant elements, they can act like filters. To this end, a band-pass filter, or filter effect from the antenna element, can attenuate any signals outside the band of operation and reduce the risk of out of band oscillation or transient behavior. Isolation between the input to output antenna ports can be focused on, such as for designing the gain. This can be advantageous if the isolation out-of-band is lower than in-band as the frequency with the lowest isolation limits the obtainable gain.

The disclosed coverage enhancing devices can be one of a number of different types of devices, which can be used interchangeably herein. For example, the CEDs can be one or more of reconfigurable intelligent surfaces (RISs), large intelligent surfaces (LISs), smart electromagnetic environment control device, network configured repeaters, repeater nodes, repeater type devices, repeaters (such as regenerative and/or non-regenerative), intelligent surfaces, and reconfigurable reflective devices (RRDs). The CEDs can have one or more antennas, such as antenna panels, antenna elements, antenna inputs, antenna outputs, and/or unit cells for meta-surfaces. The CEDs can have one or more receivers, for example low-power receivers. The CEDs can have one or more transmitters, such as an active component that provides amplification to a signal.

A coverage enhancing device can be composed of N antenna elements. Antenna elements may be connected, such as to provide a signal between antenna elements. Antenna elements may be physically connected, such as via wires. Antenna elements may be wirelessly connected. Connected antenna elements may be known as antenna pairs or paired groups of antennas.

The antenna elements can be, for example, one or more of: patch antennas, cross-dipole antennas, bowtie antennas, and slot antennas. In certain implementations, each of the antenna elements can be dually polarized.

Previously known CEDs can perform as active-gain-CEDs. For both polarizations of all antenna elements, the CED can be configured to:
Apply a phase change to the transmitted signal
Amplify the phase changed signal for provision of an amplified signal.
Transmit the amplified signal in the same polarization at the same antenna element

Certain improvements have been made to the techniques, despite requiring the use of circulators. However, circulators are not electromagnetically isolated, and with gain in the system, prohibitive crosstalk among the signals occur.

Advantageously, for different signal polarizations, such as for vertical-polarization (V-polarization) and horizontal-polarization (H-polarization), the CEDs of the disclosure can be configured to:
Apply phase changes to both received signals for different signal polarizations, such as for vertical-polarization (V-polarization) and horizontal-polarization (H-polarization), of all antenna elements the CED
Amplify the phase changed signals for provision of amplified signals.
Transmit the received V-signal corresponding to one of the amplified signals from the H-port (an antenna port having a horizontal polarization), and the received H-signal corresponding to one of the amplified signals from the V-port (an antenna port having a vertical polarization)

Polarization may vary depending on the definition of the signal. If the signal is defined as a wave with two polarization components, then: the V and H ports receive one component each. If the signal is defined as the signal entering an antenna point, then there are two signals, one at H and one at V.

While H and V polarizations are mentioned, it will be understood that different polarizations can be used, and the disclosure is not so limited. Further, a circulator, such as used to isolate the input from output of an amplifier, may not be required. In one or more example coverage enhancing devices, H and V ports can switch roles.

The disclosure can advantageously avoid the need for circulators, especially between connections of antenna elements, and can also avoid poor isolation issues between the different antenna ports, such as H and V antenna ports. That is, an amplified V-polarized-signal, intended to be transmitted from the H-port, may leak back into the V-port and be further amplified, resulting in an oscillating behaviour. However, advantageously the coverage enhancing devices of the disclosure can reduce and/or eliminate such problematic behaviours, such as by using any receiving antenna port that is spaced apart from a transmitting antenna port.

Components of the disclosed CEDs systems, such as the active components and passive components, can be advantageous to redirect signals, such as to reflect signals, transmit signals, regenerate signals, and/or retransmit signals. For example, the CEDs redirect, such as reflect, transmit, and/or retransmit, an incoming signal from a given incoming direction to a given outgoing direction. Components of the CEDs can be used to redirect, such as reflect, transmit, and/or retransmit, waves and/or signals in the mm wave spectrum, in the sub-7 GHz spectrum, or any other spectrum which may be used. Further, the components of the CEDs can be configured to make redirections of signals which appear in-phase in a certain direction and/or area.

In one or more example communication systems, the signals disclosed herein can be one or more of: energy, transmission, wave energy, FR1 and FR2 signals, 5G signals, 6G signals, sub-6 GHZ, sub-THz, THz, electromagnetic energy, waves, electromagnetic plane waves, electromagnetic signals, plane signals, spherical waves, spherical signals, cylindrical waves, and cylindrical signals. As disclosed herein, waves and signals can be used interchangeably. Signals can include orbital angular momentum (OAM) signals and/or signals with any polarization properties. The particular type of signal is not limiting.

The disclosed coverage enhancing devices can utilize passive components, such as passive fixed array panels, and active components, such as intelligent surfaces. The passive components may be passive or semi-passive components.

Components of the disclosed coverage enhancing devices systems, such as the active components and passive components, can be advantageous to reflect and/or direct and/or redirect signals. For example, the coverage enhancing devices reflect and/or direct and/or redirect an incoming signal from a given incoming direction to a given outgoing direction. As disclosed herein, reflecting and directing can be used interchangeably.

As disclosed herein, redirecting can include transmitting, reflecting, scattering, re-radiating, directing, and/or retransmitting a signal. Redirecting, transmitting, and retransmitting may be used interchangeably. The redirecting may include altering direction and/or polarization of a signal, and may further include one or more of: amplification, attenuation, termination, phase shifting, delaying, and spatial manipulation of a signal. The redirecting may also add an additional signal to the signal. Spatial manipulation may be, e.g., splitting into multiple components, widening, or in general applying any spatial filtering.

As disclosed herein, the terms signal, message, and data can be used interchangeably.

As used herein, the terms emitted, sent, and transmitted can be used interchangeably.

The figures are schematic and simplified for clarity, and they merely show details which aid understanding the disclosure, while other details have been left out. Throughout, the same reference numerals are used for identical or corresponding parts.

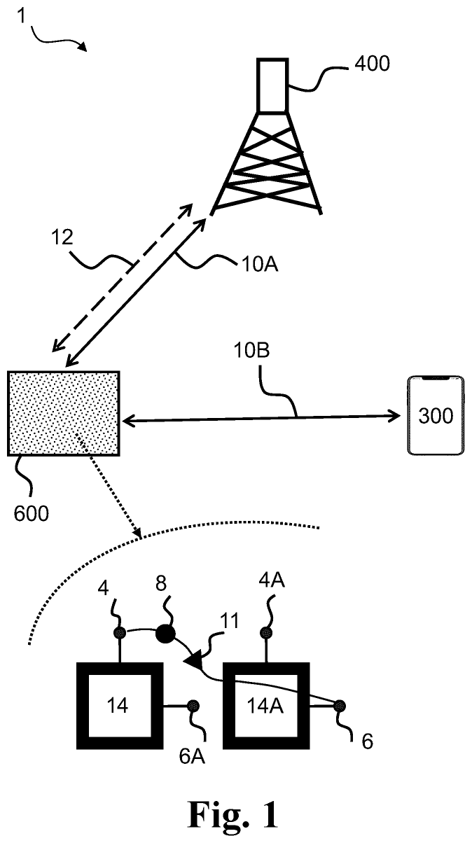

FIG. 1 is a diagram illustrating an example wireless communication system 1 comprising an example network node 400, an example coverage enhancing device 600 and an example wireless device 300 according to this disclosure.

As discussed in detail herein, the present disclosure relates to a wireless communication system 1 comprising a cellular system, for example, a 3GPP wireless communication system. The wireless communication system 1 comprises a coverage enhancing device 600. The wireless communication system 1 can comprise a wireless device 300 and/or a network node 400.

A network node 400 disclosed herein refers to a radio access network node operating in the radio access network, such as a base station, an evolved Node B, eNB, gNB in NR. In one or more examples, the RAN node is a functional unit which may be distributed in several physical units. The wireless communication system 1 described herein may comprise one or more wireless devices 300, and/or one or more network nodes 400, such as one or more of: a base station, an eNB, a gNB and/or an access point.

A wireless device may refer to a mobile device and/or a user equipment, UE.

The wireless device 300 may be configured to communicate with the network node 400 via the coverage enhancing device 600, and vice versa, such as through one or more signals (wireless link or radio access link), such as first signal 10A and/or first amplified signal 10B. As shown in FIG. 1, the coverage enhancing device 600 can receive a signal 10A from the network node 400 and retransmit the signal 10B to the wireless device 300. Further, the coverage enhancing device 600 can receive a signal 10A from the wireless device 300 and retransmit the amplified signal 10B to the network node 400.

In one or more example coverage enhancing devices, the coverage enhancing device 600 comprises at least one antenna element 14. In one or more example coverage enhancing devices, the coverage enhancing device 600 comprises a first antenna port 4. The first antenna port 4 is associated with the at least one antenna element 14 and configured to receive a first signal 10A. In one or more example coverage enhancing devices, the coverage enhancing device 600 comprises an amplifier 11. The amplifier 11 can be in communication with the first antenna port 4. The amplifier 11 can be configured to amplify the first signal 10A for provision of a first amplified signal 10B. In one or more example coverage enhancing devices, the coverage enhancing device 600 comprises a second antenna port 6. The second antenna port 6 can be in communication with the amplifier 11. The second antenna port 6 can be configured to transmit the first amplified signal 10B. In one or more example coverage enhancing devices, the second antenna port 6 is a different antenna port than the first antenna port 4. In one or more example CEDs, the first antenna port 4 forms at least a part of a first antenna element of the at least one antenna element 14. In one or more example CEDs, the second antenna port 6 forms at least a part of a second antenna element of the at least one antenna element 14.

The coverage enhancing device 600 may further include a phase changer 8, an antenna port 6A and an antenna port 4A. For illustrative purposes, the first signal shown in FIG. 1 as signal 10A is received by the coverage enhancing device 600 from the base station 400, and the first amplified signal 10B is transmitted by the coverage enhancing device 600 towards the user equipment 300. However, the coverage enhancing device 600 can direct, receive, and retransmit a signal in the opposite fashion, e.g., reciprocal, though not necessarily identical. The antenna element 14 and antenna element 14A can be considered an antenna element pair. Further, as discussed herein, the coverage enhancing device 600 of FIG. 1 may be coverage enhancing device 500 and/or 500A, including their respective components.

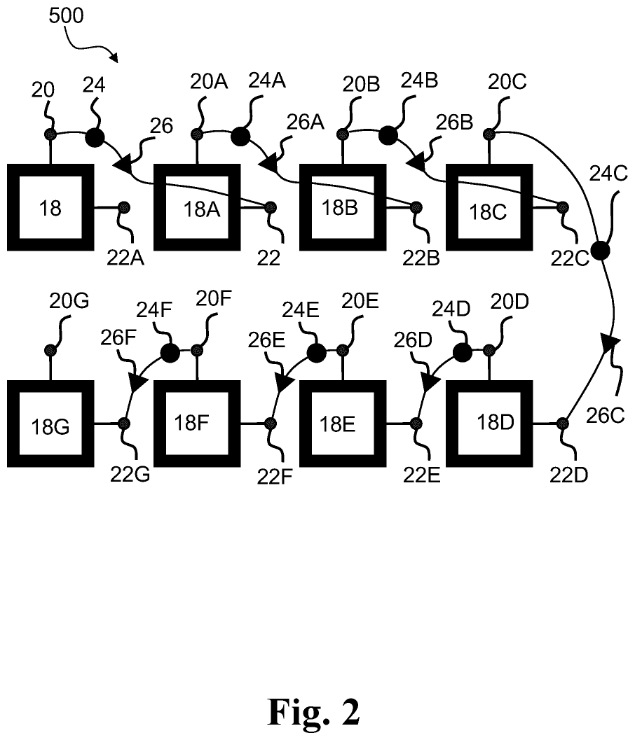

FIG. 2 is a diagram illustrating an example coverage enhancing device 500. The coverage enhancing device 500 can include any and/or all elements of coverage enhancing device 600. As shown, the coverage enhancing device 500 can include at least one antenna element 18. The coverage enhancing device can optionally include one or more additional antenna elements, such as a plurality of antenna elements, 18A, 18B, 18C, 18D, 18E, 18F, 18G. The antenna elements 18, 18A, 18B, 18C, 18D, 18E, 18F, 18G may be connected, such as shown in FIG. 2. The antenna elements 18, 18A, 18B, 18C, 18D, 18E, 18F, 18G, may form a chain of antenna elements. Directly connected antenna elements, such as antenna element 18 and 18A, or 18A and 18B, may be known as antenna element pairs.

As discussed herein, the at least one antenna element 18 may be an antenna and/or a portion of an antenna. The at least one antenna element 18 may be an antenna patch. An antenna element 18 may be an antenna element of an antenna array.

An antenna port, such as the first antenna port 20 and/or the second antenna port 22, may be configured to receive and/or transmit a signal, such as the first signal 10A and/or the first amplified signal 10B. The second antenna port 22 can be associated with the at least one antenna element 18. The first antenna port 20 and/or the second antenna port 22 may have a particular polarization.

The second antenna port 22 can be different from the first antenna port 20, which can reduce self-oscillation. For example, by separating the second antenna port 22 from the first antenna port 20, coupling between receiving (Rx) and transmitting (Tx) signals can be reduced on a reflection surface of the coverage enhancing device 500, thereby avoiding self-oscillation, and allowing for reasonable amplification gain by amplifier 26. The second antenna port 22 can be located at a different position from the first antenna port 20.

An amplifier 26 can be configured to amplify a signal, such as add gain to a signal. For example, an amplifier 26 may amplify first signal 10A for provision of first amplified signal 10B. The amplifier 26 may be any type of amplifier, such as uni-directional and/or bi-directional, and the particular type of amplifier is not limiting. The amplifier 26 can be positioned between the first antenna port 20 and the second antenna port 22 to amplify the first signal 10A. In one or more example coverage enhancing devices, the coverage enhancing device 500 includes low-noise amplifiers (LNAs) as the amplifier 26, that are e.g. uni-directional. However, other types of amplifiers can be used which are bi-directional.

In one or more example coverage enhancing devices, the coverage enhancing device 500 is configured to amplify the first signal at a loop gain of below 1. The loop gain can be the loop gain between a transmitting antenna port and a receiving antenna port, such as between the second antenna port and the first antenna port. In one or more example coverage enhancing devices, the coverage enhancing device 500 is configured to have no leakage.

In one or more example coverage enhancing devices, the coverage enhancing device 500 does not include a circulator. In one or more example coverage enhancing devices, the coverage enhancing device 500 does not include a circulator between the first antenna port 20 and the second antenna port 22. In one or more example coverage enhancing devices, the coverage enhancing device 500 does not include circulators in the input and in the output of the amplifier 26.

In one or more example coverage enhancing devices, the coverage enhancing device 500 further comprises a phase changer 24 configured to change the phase of the first signal 10A.

For example, the coverage enhancing device 500 is configured to change the phase of the first signal 10A and then amplify the phase changed first signal 10A for provision of a phase changed first amplified signal 10B. As an example, the phase changer 24 can change a phase of the first signal 10A. The phase changer 24 may be positioned between the first antenna port 20 and the second antenna port 22. The phase changer 24 may be located so that a phase of the first signal 10A is changed prior to amplification by the amplifier 26. The phase changer 24 can be configured to change a phase of the first signal 10A for provision of a phase changed signal. The amplifier 26 can be configured to amplify the phase changed signal for provision of the first amplified signal 10B. The particular type of phase changer is not limiting.

In one or more example coverage enhancing devices, the coverage enhancing device 500 is an active gain coverage enhancing device. In one or more example coverage enhancing devices, the coverage enhancing device 500 is a passive gain coverage enhancing device.

In one or more example coverage enhancing devices, the first antenna port 20 forms at least a part of a first antenna element of the at least one antenna element 18 and the second antenna port 22A forms at least a part of the first antenna element.

For example, both the first antenna port 20 and the second antenna port 22A may form a part of (such as be a part of, attached to, integral with, located on, associated with) the same antenna element, such as a first antenna element (shown in FIG. 2 as antenna element 18). The first antenna element can be configured to receive the first signal 10A via the first antenna port 20 forming a part of the first antenna element. The first antenna element may be configured to amplify the first signal 10A for provision of the first amplified signal 10B. The first antenna element may be configured to transmit the first amplified signal 10B via the second antenna port 22A. In one or more example coverage enhancing devices, the received first signal 10A may be received, amplified, and transmitted on the same antenna element. In one or more example coverage enhancing devices, the amplifier may form a part of a single antenna element 18, such as connecting the first antenna port 20 to the second antenna port 22A.

For example, the first antenna port 20 and the second antenna port 22A may be orthogonal to one another. The first antenna port 20 and the second antenna port 22A may have different polarizations.

In one or more example coverage enhancing devices, the first antenna port 20 forms at least a part of a first antenna element of the at least one antenna element 18 and the second antenna port 22 forms at least a part of a second antenna element of the at least one antenna element 18A.

As an example, CED 500 can be an antenna, such as an array of one or more antenna elements, such as an antenna array. In one or more example CEDs, an antenna element is a galvanic antenna unit and/or structure that may have one or two antenna ports. Two antenna ports can be connected to orthogonally polarized modes. An antenna port can be a feed point of an antenna element that is associated with one of the radiating modes, such as polarizations. A unit cell can be a group of one or more antenna elements that collectively fulfil a task, such as receive and retransmit, such as apply a gain and/or a phase shift. The antenna port may form a part of an antenna element in that the antenna port is associated with a particular antenna element.

For example, the first antenna port 20 may form a part of (such as be a part of, attached to, integral with, located on, associated with) a different antenna element than the antenna element the second antenna port 22 forms a part of. The first antenna port 20 may form a part of a first antenna element (illustrated as antenna element 18 in FIG. 2) and the second antenna port 22 may form a part of a second antenna element (illustrated as antenna element 18A in FIG. 2).

The at least one antenna element 18 can include a first antenna port 20. The at least one antenna element 18A can include a second port 22 located on a different antenna element. As shown, the coverage enhancing device 500 can include an amplifier 26 in communication with the first antenna port 20. The coverage enhancing device 500 can include a second antenna port in communication with the amplifier 26. As shown in FIG. 2, the second antenna port 22 can form at least a part of a second antenna element 18A. Optionally, a phase changer 24 can be used between the connection of the first antenna port 20 and the second antenna port 22. The at least one antenna element 18 can include a second antenna port 22A as well.

In one or more example coverage enhancing devices, the coverage enhancing device 500 can include a respective amplifier 26, 26A, 26B, 26C, 26D, 26E, 26F between antenna elements 18, 18A, 18B, 18C, 18D, 18E, 18F, 18G, such as between first antenna ports 20, 20A, 20B, 20C, 20D, 20E, 20F and second antenna ports 22, 22A, 22B, 22C, 22D, 22E, 22F, 22G.

In one or more example coverage enhancing devices, the coverage enhancing device 500 can include a respective phase changer 24, 24A, 24B, 24C, 24D, 24E, 24F between antenna elements 18, 18A, 18B, 18C, 18D, 18E, 18F, 18G, such as between first antenna ports 20, 20A, 20B, 20C, 20D, 20E, 20F and second antenna ports 22, 22A, 22B, 22C, 22D, 22E, 22F, 22G. The phase changer 24 can be configured to change a phase of the first signal 10A received by the coverage enhancing device 500.

As shown in FIG. 2, two ports, 22A and 20G, are left unspecified (such as unconnected). These ports 22A and 20G can be terminated (e.g., they are not used). These ports 22A and 20G can be used to transmit a V-polarized signal from an H-port. In other words, the first antenna port 20G and/or the second antenna port 22A may be configured to receive and/or transmit a signal, such as signals similar to the first signal 10A and/or the first amplified signal 10B.

In particular, FIG. 2 illustrates a coverage enhancing device 500 with 8 antenna elements, and thus N=8.

In one or more example coverage enhancing devices, the first antenna port 20 has a different polarization than the second antenna port 22.

For example, the first antenna port 20 can have a first polarization and the second antenna port 22 can have a second polarization. The first antenna port 20 can transmit and/or receive a signal in a first polarization and the second antenna port 22 can transmit and/or receive a signal in a second polarization. In other words, mathematically anything sent by this antenna port has a polarization vector [A B]′.

Now, both A and B can be non-zero as polarization is measured in a reference coordinate system. If this reference coordinate system is taken as the internal antenna coordinate system, then either A or B is 0.

The polarization may be orthogonal polarization. The polarization can be linear polarization. The polarization can be left-hand and right-hand polarization. The polarization can be circular polarization.

In one or more example coverage enhancing devices, the first antenna port 20 can be a vertical polarization antenna port (V port, designated as Vₙ) and the second antenna port 22 can be a horizontal polarization antenna port (H port, designated as Hₙ), where n is the number of ports, such as running from 1 to N, where N is the number of antenna elements.

For example, let Vₙ and Hy denote the V ports (such as first antenna ports 20, 20A, 20B, 20C, 20D, 20E, 20F, 20G) and H ports (such as second antenna ports 22, 22A, 22B, 22C, 22D, 22E, 22F, 22G) of antenna element n (such as antenna elements 18, 18A, 18B, 18C, 18D, 18E, 18F, 18G), respectively. To obtain advantageous isolation:

For antenna elements, n=1 . . . . N−1,
Optionally apply a phase change, via phase changer 24, 24A, 24B, 24C, 24D, 24E, 24F, to the received signal (such as, the first signal 10A) at port Vₙ (such as, first antenna port 20, 20A, 20B, 20C, 20D, 20E, 20F)·
Amplify, via amplifier 26, 26A, 26B, 26C, 26D, 26E, 26F, the phase changed signal for provision of the first amplified signal (such as, the first amplified signal 10B).
Transmit the first amplified signal (such as, the first amplified signal 10B) from port Hₙ₊₁ (such as, second antenna port 22, 22B, 22C, 22D, 22E, 22F, 22G)

As the first amplified signal 10B is being transmitted far apart from its source, where first signal 10A is received, isolation can be improved. In other words, a first signal 10A is received by port Vₙ at the first antenna element, but the first amplified signal 10B is then transmitted/reflected by port Hn+1, which may belong to a second antenna element different from the first antenna element. As used herein, far apart can be the next antenna element, such as a next and/or nearby antenna element or a diagonal antenna element. Far apart can be antenna elements with an offset that is in the order of a wavelength of the signal. For example, the first amplified signal 10B can be transmitted 0.5, 1.0, 1.5, 2.0, 2.5, 3.0 etc. wavelengths of the first signal away.

The isolation between the input port and output port (such as second antenna port 22 and first antenna port 20A) to the amplifier (such as amplifier 26A) is related to the gain of the amplification where the loop gain is lower than 1. If higher gain would be needed, it is possible to further improve the isolation by connecting the V-port of antenna element n to H-port of antenna element n+2 or even antenna element n+3, and so on and so forth. On the other hand, if the gain of the amplifier is low enough, it is also possible to connect the V-port to the H-port on the same antenna element, such as antenna element 18 using first antenna port 20 and second antenna port 22A, to receive and transmit a signal, such as the first signal 10A and the first amplified signal 10B. In one or more example coverage enhancing devices, it is possible to go beyond the adjunct element and also use the same antenna element but orthogonal ports.

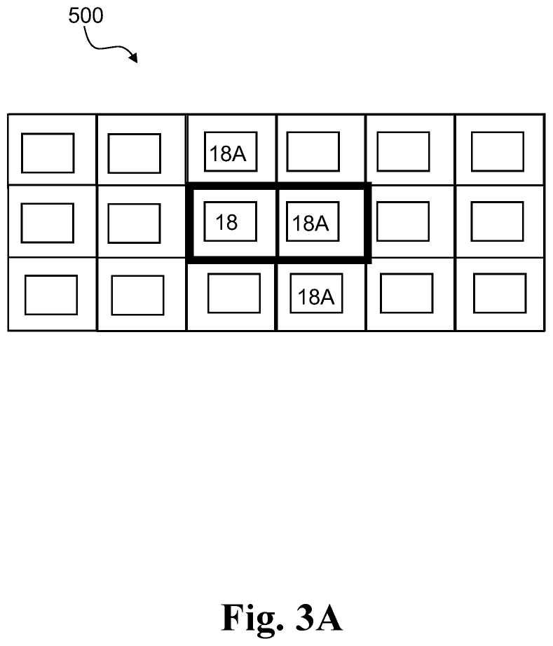

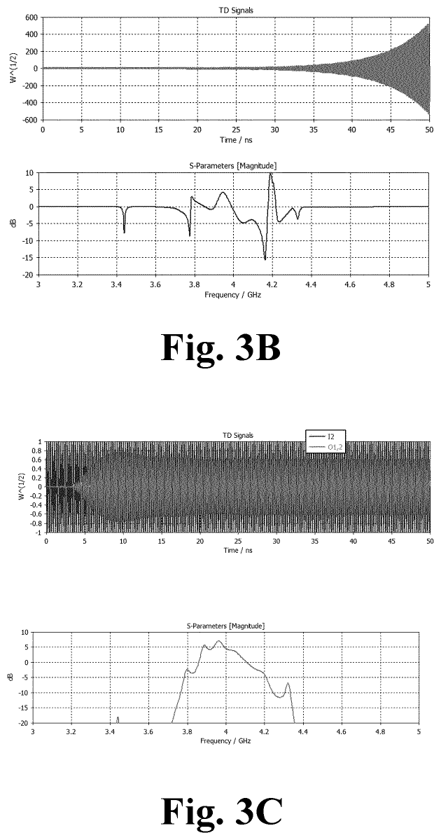

FIGS. 3A-3C illustrate a full wave simulation for an example coverage enhancing device 500 of the disclosure. A coverage enhancing device operating at 4 GHZ (shown in FIG. 3A) is simulated and each power amplifier (PA) has a gain of 10 dB. As shown in FIG. 3A, antenna element 18 can be vertically next to, horizontally next to, or diagonally next to antenna element 18A. Two cases are compared in the simulation with a high coupling case (−5 dB coupling, realized with V-port of patch n to V-port of patch n+1), and a low coupling case (−35 dB coupling realized with V-port of patch n to H-port of patch n+1). With a sine wave input signal at 4 GHZ, though amplification, it can be observed in both cases that the high coupling case faces significant issues on oscillation, which is shown in the transient simulation results, while no oscillation is observed in the low coupling case. FIG. 3B illustrates a high coupling connection of −5 dB and FIG. 3C illustrates a low coupling connection of −35 dB.

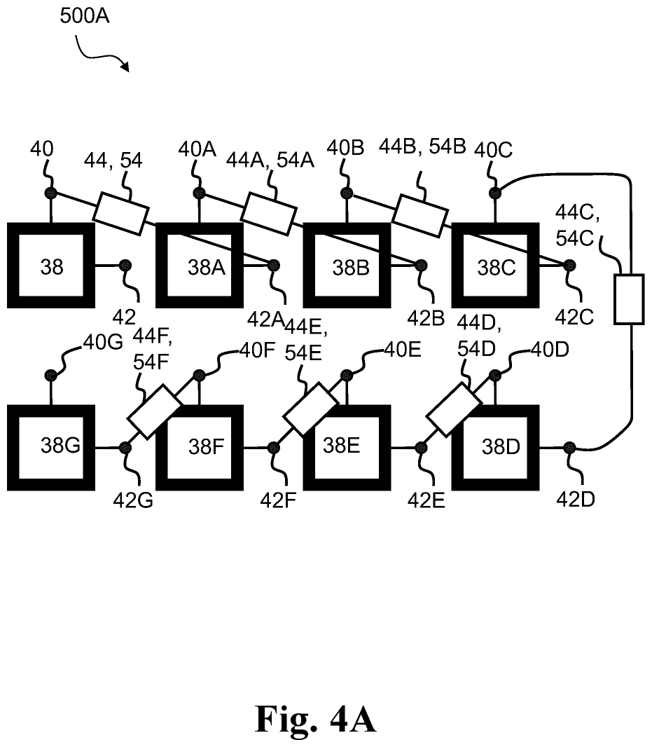

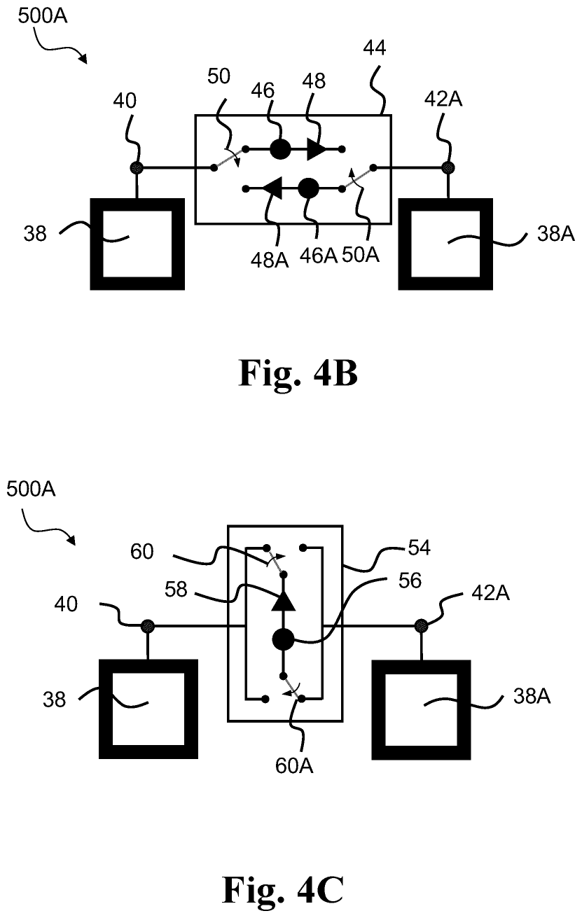

FIGS. 4A-4C are diagrams illustrating an example coverage enhancing device 500A. The coverage enhancing device 500A can include any and/or all of the features discussed above with respect to coverage enhancing device 600, 500 (such as discussed in FIGS. 1-3C).

Another advantage of the disclosed coverage enhancing devices is the ability for the coverage enhancing devices to operate as a rank 1 channel and/or a rank 2 channel, such as by using coverage enhancing device 500A discussed in FIGS. 4A-4C. In one or more example coverage enhancing devices, the coverage enhancing device 500A can change between a rank 1 channel and a rank 2 channel. In one or more example coverage enhancing devices, the coverage enhancing device 500A is configured to support rank 1 and/or rank 2 transmissions. In one or more example coverage enhancing devices, the coverage enhancing device 500A is configured to use rank 1 and/or rank 2 channels.

For example, a rank 1 transmission may only allow a single signal, e.g., one independent data stream, to be sent in the same time resource and/or time-frequency resource through a particular channel. For example, a rank 1 transmission may allow the transmission of two signals, but a reduction in the generated inter-user interference may not be possible. In a rank 2 transmission, two signals, e.g., two independent data streams, may be sent in the same time resource through a particular channel. For example, having a network node 400, to reach rank 2 a coverage enhancing device must have at least two antennas, receiving two independent data streams in the same time resources (and linearly separating). For rank 1, only 1 data stream can be sent.

In other words, it is the rank of the channel that sets a limit to the rank of the transmission. That is, K<=L. If the rank of the channel is L=1, then transmitting with rank K=2 will generate inter-user interference. But if L=2, and K=1, then the rank can be changed to K=2 and avoid interference. As shown in FIGS. 4B-4C, a channel with rank L=2 is created if the switches are set in a certain state. If not, the channel rank L=1 and the transmission is rank K=1.

Channel ranks can be understood as follows. Let channel rank L=1, and let there be two values x and y at the transmitter. Since L=1, it is impossible to obtain two linearly independent equations/observations with x and y at the receiver. In, fact, only one observation is obtained at the receiver, such as r1=x+y. From this single observation, x and y cannot be decoded independently. If L=2, then the receiver can obtain two observations, such as R1=x+y and R2=x−y, from x,y can be obtained as x=(R1+R2)/2 and y=(R1−R2)/2. For example, far-field transmissions to and from the coverage enhancing device 600, 500, 500A are illustrated. Let x=[x_{V} x_{H}]^{T} denote the transmitted signal (such as first signal 10A) from the source (for example the network node 400 transmitting towards the coverage enhancing device 500) in the V and H polarizations, respectively. Further, let y=[y_{V} y_{H}]^{T} denote the received signal (such as first amplified signal 10B) at the sink (for example the wireless device 300 towards which the coverage enhancing device 500 transmits) in the V and H polarizations, respectively. Let R(α) denote a 2×2 rotation matrix with rotation angle α. With that, the input output model, in the absence of noise, of the coverage enhancing device 500 in FIG. 2:

$$[ \begin{matrix}{y}_{V} \\ {y}_{H}\end{matrix} ] = R ( {α}_{1} ) [ \begin{matrix}0 & 0 \\ A & 0\end{matrix} ] R ( {α}_{2} ) [ \begin{matrix}{x}_{V} \\ {x}_{H}\end{matrix} ] \qquad ( 1 )$$

where A denotes a complex-valued scalar that depends on that path-losses, the applied phase changes, and the applied gains. It can be seen in the equation (1) that the effective channel matrix, i.e.,

$$R ( {α}_{1} ) [ \begin{matrix}0 & 0 \\ A & 0\end{matrix} ] R ( {α}_{2} ) ,$$

is rank 1. As a direct consequence, only rank 1 transmission can be supported.

However, the coverage enhancing device 500 having a rank 1 system can be changed into a rank 2 system, such as the system discussed with coverage enhancing device 500A, by

$$[ \begin{matrix}{y}_{V} \\ {y}_{H}\end{matrix} ] = R ( {α}_{1} ) [ \begin{matrix}0 & ( 1 - β ) A \\ β A & 0\end{matrix} ] R ( {α}_{2} ) [ \begin{matrix}{x}_{V} \\ {x}_{H}\end{matrix} ] , 0 \leq β \leq 1. \qquad ( 2 )$$

First note that the former system is a special case of the latter where β=1. The spectral efficiency of the latter system is:

$$C = {log}_{2} ( 1 + \frac{{β}^{2} {A}^{2}}{{N}_{0}} ) + {log}_{2} ( 1 + \frac{{( 1 - β )}^{2} {A}^{2}}{{N}_{0}} ) . \qquad ( 3 )$$

In general, when A²/N₀ is small (e.g., low signal-to-noise ratio (SNR)), the capacity is improved for β=0 (or β=1) compared with β=1/2. Note that β is, for now, to be regarded as an auxiliary variable without any physical interpretation put upon it. Its mathematical model can coincide with that in (2), for an arbitrary β. For large A²/N₀ (e.g., high signal-to-noise ratio (SNR)), the capacity is improved for β=0.5. Thus, the coverage enhancing device 500 provides an improved performance at low SNR, but not at high SNRs. Therefore, it can be advantageous to use an adaptive coverage enhancing device, such as coverage enhancing device 500A, which can switch between the two models according to the SNR.

Other values of β may be used as well. In one or more example coverage enhancing devices, values β=0, 0.5, 1 can be particular advantageous. As coverage enhancing device 500 already shows how to obtain β=0, coverage enhancing device 500A can be used to obtain β=0.5.

β denotes the fraction of V-H to H-V configurations to total number of configurations. For example, a V-H configuration (e.g., β=0) can imply that an antenna port, such as a first antenna port and/or a second antenna port, may be configured to receive and/or transmit a signal, such as the first signal and/or the first amplified signal.

For example, a H-V configuration (e.g., β=1) can imply that an antenna port, such as a second antenna port and/or a first antenna port, may be configured to receive and/or transmit a signal, such as the first signal and/or the first amplified signal.

For example, a CED supporting a same number of V-H and H-V configurations can imply β=0.5.

As shown in FIGS. 4A-4C, each connector 44, 54 may include at least one switch 50, 50A, 60, 60A. Each connector 44, 54 may include a pair of switches 50, 50A and 60, 60A. The connector 44, 54 and/or switch 50, 50A, 60, 60A may have two states, 0 or 1, based on the respective switch 50, 50A, 60, 60A positions. FIG. 4B illustrates the connector 44 at an intermediate state between 0 and 1. FIG. 4C illustrate the connector 54 at state 0. At state 1, both switches 50, 50A and 60, 60A change positions. In one or more example coverage enhancing devices, the second antenna port 42A is configured to receive a second signal. In one or more example coverage enhancing devices, the amplifier 48, 48A, 58 is configured to amplify the second signal for provision of a second amplified signal. In one or more example coverage enhancing devices, the first antenna port 20 is configured to transmit the second amplified signal. This configuration may allow the configuration enhancing device 500A to have a capability to use both rank 1 and rank 2 transmissions. Accordingly, the coverage enhancing device 500A can allow for bi-directional signal communications.

In one or more example coverage enhancing devices, each antenna element 38, 38A, 38B, 38C, 38D, 38E, 38F, 38G may each have four ports. Taking antenna element 38 as an example, antenna element 38 may have first antenna port 40 (designated p1), second antenna port 42 (designated p2), third antenna port (designated p3), and fourth antenna port (designated p4). P3 and p4 are not shown in the figures. First antenna port p1 and third antenna port p3 may have the same polarization. Second antenna port p2 and fourth antenna port p4 may have the same polarization, which is different from the first polarization of p1 and p3.

For example, the first antenna port p1 can receive a first signal, amplify the signal, and transmit it from the second antenna port p2. The fourth antenna port p4 can receive a second signal, amplify it, and send it from the third antenna port p3.

The first antenna port p1 and the third antenna port p3 may be in different physical locations. The second antenna port p2 and the fourth antenna port p4 may be in different physical locations. The first antenna port p1, the second antenna port p2, the third antenna port p3, the fourth antenna port p4 may be located on a single antenna element, such as antenna element 38. The first antenna port p1 and the second antenna port p2 can be located on a different antenna element than the third antenna port p3 and the fourth antenna port p4.

FIG. 4A illustrates 8 antenna elements, so N=8. As shown, the coverage enhancing device 500A can include at least one antenna element 38 (such as antenna elements 38A, 38B, 38C, 38D, 38E, 38F, 38G). The at least one antenna element 38 can include any and/or all of the features discussed above with respect to the at least one antenna element 18 (such as discussed in FIGS. 1-3C). For example, the at least one antenna element 38 can include a first antenna port 40 in communication with a second antenna port 42A. The first antenna port 40 can include any and/or all of the features discussed above with respect to the first antenna port 20 (such as discussed in FIGS. 1-3C). The second antenna port 42A can include any and/or all of the features discussed above with respect to the first antenna port 22 (such as discussed in FIGS. 1-3C).

The respective antenna elements 38, 38A, 38B, 38C, 38D, 38E, 38F, 38G can include a respective first antenna port 40, 40A, 40B, 40C, 40D, 40E, 40F, 40G. The respective antenna elements 38, 38A, 38B, 38C, 38D, 38E, 38F, 38G can include a respective second antenna port 42, 42A, 42B, 42C, 42D, 42E, 42F, 42G.

In one or more example coverage enhancing devices, a connector 44, 54 may connect the first antenna port 40 with the second antenna port 42A. The connector 44, 54 may be a physical device or may be representative of the components within the virtual connector 44, 54.

Each connector 44, 54 may include an amplifier 48, 48A, 58. The amplifier 48, 48A, 58 can include any and/or all of the features discussed above with respect to the amplifier 26 (such as discussed in FIGS. 1-3C). Each connector 44, 54 may include a phase changer 46, 46A, 56. The phase changer 46, 46A, 56 can include any and/or all of the features discussed above with respect to the phase changer 24 (such as discussed in FIGS. 1-3C).

In one or more example coverage enhancing devices, the coverage enhancing device 500A comprises at least one switch 50, 50A, 60, 60A in communication with (such as connecting) the first antenna port 40 to the second antenna port 42A. In one or more example coverage enhancing devices, the at least one switch 50, 50A, 60, 60A is configured to provide, in a first position, a connection in a first direction from the first antenna port 40 to the second antenna port 42A. In one or more example coverage enhancing devices, the switch 50, 50A, 60, 60A is configured to provide, in a second position, a connection in a second direction from the second antenna port 42A to the first antenna port 40.

FIG. 4B illustrates a diagram of a coverage enhancing device 500A incorporating connector 44 in communication with (such as connecting) first antenna port 40 with second antenna port 42A. As shown in FIG. 4B, connector 44 can include a switch 50 and a switch 50A. When the switches 50, 50A are in a first position, any signal can flow from first antenna port 40 to second antenna port 42A. When the switches 50, 50A are in a second position, any signal can flow from the second antenna port 42A to the first antenna port 40. For illustrative purposes, FIG. 4B illustrates a position where no signal is flowing. In order to be in the first position, switch 50A can be switched. In order to be in the second position, switch 50 can be switched. A pair of amplifiers 48, 48A can be used and a pair of phase changes 46, 46A can be used.

FIG. 4C illustrates a diagram of a coverage enhancing device 500A incorporating connector 54 in communication with (such as connecting) first antenna port 40 with second antenna port 42A. As shown in FIG. 4C, connector 54 can include a switch 60 and a switch 60A. When the switches 60, 60A are in a first position, any signal can flow from first antenna port 40 to second antenna port 42A. When the switches 60, 60A are in a second position, as shown in FIG. 4, any signal can flow from the second antenna port 42A to the first antenna port 40. Advantageously, a single phase changer 56 and a single amplifier 58 can be used.

In one or more example coverage enhancing devices, the coverage enhancing device 500A is configured to receive a switch configuration signal 12. In one or more example coverage enhancing devices, the coverage enhancing device 500A is configured to, based on the switch configuration signal, to set the switch 50, 50A, 60, 60A in the first position or the second position.

For example, the coverage enhancing device 500A can receive a switch configuration signal 12 from network node 400.

In one or more example coverage enhancing devices, all antenna elements of the coverage enhancing device 500A can include switches, thereby making them adaptive (e.g., dynamic). In one or more example coverage enhancing devices, only a portion of antenna elements of the coverage enhancing device 500A may include switches. For example, a block of N antenna elements of the coverage enhancing device 500A can have a switch in the same position, and may still be adaptive. In one or more example coverage enhancing devices, half of the antenna elements have no switch, and the other half do. All these switches can be set in the same direction to have the CED 500A supporting rank 1 transmissions, and all the antenna elements with switches can be switched to have the CED 500A supporting rank 2 transmissions.

In one or more example coverage enhancing devices, the at least one antenna element 38 comprises a plurality of first direction antenna element each having a respective switch set to the first position. In one or more example coverage enhancing devices, the at least one antenna element 38 comprises a plurality of second direction antenna elements each having a respective switch set to the second position. In one or more example coverage enhancing devices, a number of the plurality of first direction antenna elements is equal to a number of the plurality of second direction antenna elements.

In one or more example coverage enhancing devices, the ratio of first direction antennas to second direction ones is configurable and depends on the properties of the channels, as well as on the intended objective (e.g., maximize sum-rate, maximize the minimum rate, etc.). For example, there can be cases when the ratio should not be 50/50. With specific channels, and advanced systems to cope with those, the ratio can be different.

For example, to obtain β=0.5 using coverage enhancing device 500, half of the amplifiers 26, 26A, 26B, 26C, 26E, 26F can be “run backwards”. This can be easily performed with the switching of coverage enhancing device 500A. For example, to achieve β=0.5, some connectors 44, 44A, 44B, 44C, 44D, 44E, 44F, 54, 54A, 54B, 54C, 54D, 54E, 54F can be in state 0 and some can be in state 1, as long as half of them are in state 1. This can also be done in the coverage enhancing 500, as half of the amplifiers 26, 26A, 26B, 26C, 26E, 26F can be set in one direction and half the other direction, which can be hardware efficient, e.g., such a configuration can require less hardware. For an adaptive coverage enhancing device 500A, the network node 400 could configure the coverage enhancing device 500A to put half of the connectors 44, 44A, 44B, 44C, 44D, 44E, 44F, 54, 54A, 54B, 54C, 54D, 54E, 54F in state 0 or 1, such as the coverage enhancing device 500A receiving the switch configuration signal 12. By switching the switches back and forth, a rank 1 channel can be created (e.g., the CED provides an improved performance at low SNR), or a rank 2 channel is created (e.g., the CED provides an improved performance at high SNR).

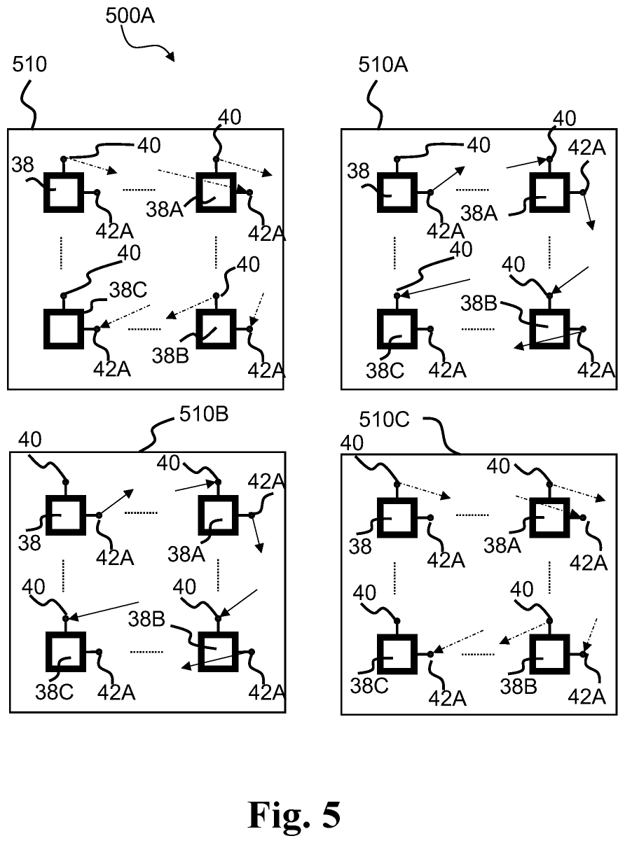

FIG. 5 illustrates a diagram of a coverage enhancing device 500A having a plurality of subpanels 510, 510A, 510B, 510C. The subpanels may be virtual subpanels or physical subpanels. Each subpanel 510, 510A, 510B, 510C can include a plurality of antenna elements 38, 38A, 38B, 38C. For each subpanel 510, 510A, 510B, 510C, antenna elements 38, 38A, 38B, 38C (n and n+1) can be adaptively linked in the V->H direction (e.g., first antenna port has a V-polarization and second antenna port has an H-polarization) or in the H->V direction (e.g., first antenna port has a H-polarization and second antenna port has an V-polarization).

For convenience, each antenna element 38, 38A, 38B, 38C includes a respective first antenna port 40 which is a V-port and a respective second antenna port 42A which is a H-port.

As shown, subpanels 510 and 510C are set to a V-H configuration (e.g., the signal, such as the first signal 10A, is moving from a first antenna port 40 (such as a V-port) to a second antenna port 42A (such as a H-port) whereas subpanels 510A and 510B are set to a H-V configuration (e.g., the signal, such as the second signal, is moving from a second antenna port 42A (such as a H-port) to a first antenna port 40 (such as a V-port).

In one or more example coverage enhancing devices, all antenna elements 38, 38A, 38B, 38C within a sub-panel 510, 510A, 510B, 510C may operate in the same way, e.g., either H->V or V->H, as shown in FIG. 5. In FIG. 5, 4 sub-panels 510, 510A, 510B, 510C are shown where all antenna elements 38, 38A, 38B, 38C within a respective subpanel 510, 510A, 510B, 510C are equally configured.

Adapting between rank 1 and rank 2 would imply that each subpanel 510, 510A, 510B, 510C can be configured to either V->H or H->V. If rank 2 is always desired, then the sub-panels 510, 510A, 510B, 510C can be configured according to FIG. 5 at fabrication. If both rank 2 and rank 1 are to be used, the coverage enhancing device 500A can be reconfigurable, as described above with respect to the use of switches.

The order of connections among antenna elements can be arbitrary and does not have to follow FIGS. 2, 4A, 4B, 4C, and 5.

In one or more example coverage enhancing devices, a coverage enhancing device 500A can be configured to support both rank 1 and rank 2 polarization multiple-input and multiple-output (MIMO) to a network node 400. The network node 400 can send a switch configuration signal 12 which is configured to set the coverage enhancing device 500A for rank 1 or rank 2 transmissions. For example, the coverage enhancing device 500A can have a layout, such as shown in FIGS. 4A-4C, where each connector 44, 54 is set to 0 or 1. The coverage enhancing device 500A can have a layout, such as shown in FIG. 5, where each subpanel 510, 510A, 510B, 510C is configured either for V->H or H->V.

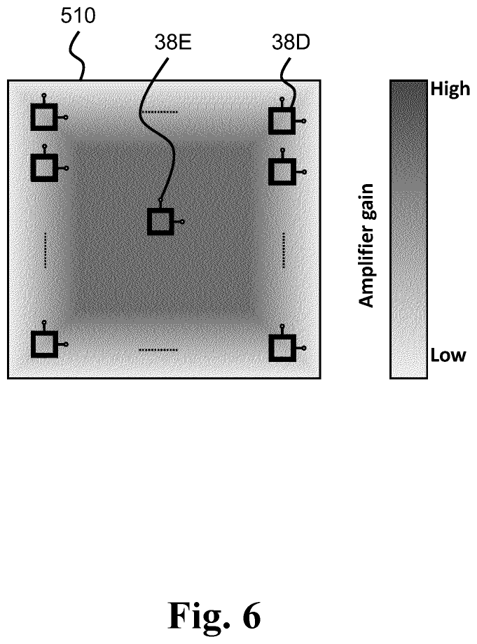

To further improve isolation, the gains of the antenna elements at each subpanel (for example 510) can be manipulated as shown in FIG. 6. The gains associated with the outer antenna elements 38D of a subpanel 510 are lower than those of the inner antenna element 38E. Amplifiers close to the edge of a subpanel 510 are configured with less gain than those close to the center of subpanel 510. This can improve isolation between subpanels, as there is less power leakage from antenna elements 38D located at the edge of the subpanel 510. For example, there is less power distributed around the edge of each subpanel 510, and thus less power can be coupled to the neighboring subpanels.

In one or more example coverage enhancing devices, the at least one antenna element comprises a chain of antenna elements. In one or more example coverage enhancing devices, the chain of antenna elements comprises a beginning antenna element, an ending antenna element, and a plurality of middle antenna elements. In one or more example coverage enhancing devices, each antenna element of the chain of antenna elements has respective first antenna ports and respective second antenna ports. In one or more example coverage enhancing devices, each first antenna port of the plurality of middle antenna elements is in communication, via a respective amplifier, with the second antenna port of a different antenna element of the plurality of middle antenna elements.

In one or more example coverage enhancing devices, each first antenna port of the plurality of middle antenna elements is in communication, via a respective amplifier, with the second antenna port of an adjacent antenna element of the plurality of middle antenna elements.

For example, FIG. 2 illustrates a chain of antenna elements having a beginning antenna element 18, a plurality of middle antenna elements 18A, 18B, 18C, 18D, 18E, 18F, and an ending antenna element 18G.

Similarly, FIG. 4A illustrates a chain of antenna elements having a beginning antenna element 38, a plurality of middle antenna elements 38A, 38B, 38D, 38D, 38E, 38F, and an end antenna element 38G.

For example, as shown, a first port 40 of antenna element 38 (beginning antenna element) can be connected to a second port 42A of a different antenna element 38A (middle antenna element). The middle antenna element 38A may be adjacent (such as neighboring) to the beginning antenna element 38, or spaced apart (even via other middle antenna elements). Beginning antenna element 38 may be connected to middle antenna element 38A via first antenna port 40 to second antenna port 42A. Middle antenna element 38A may be connected, via first port 40A of middle antenna element 38A, to middle antenna element 38B, such as via second port 42B. This construction can continue, such as shown in FIG. 4A, until reaching end antenna element 38G. End antenna element 38G may only be connected to a middle antenna element 38F through the second antenna port 42G of end antenna element 38G. Neighboring antenna elements may be within a particular subpanel, such as subpanel 510 of FIG. 5. All antenna elements shown in FIG. 4A may be on a single subpanel. The particular number of antenna elements is not limiting.

Depending on the connections, any of the plurality of middle antennas 38A, 38B, 38D, 38D, 38E, 38F can act as a beginning or ending antenna element. Further, in one or more example CEDs, the CED may only have one beginning antenna and one ending antenna and no middle antennas.

Further, the discussion of FIG. 4A can also relate to the CED 500 of FIG. 2.

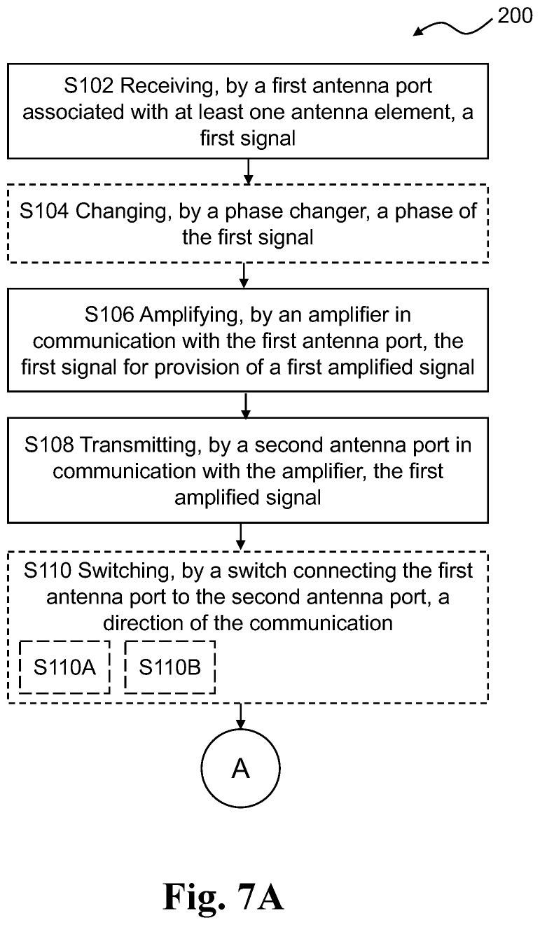

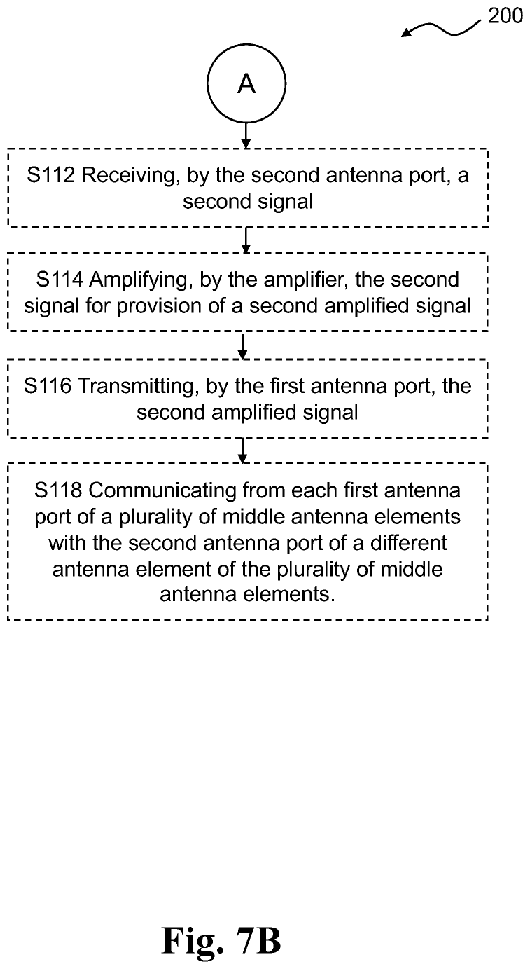

FIGS. 7A-7B show a flow diagram of an example method 200, performed by a coverage enhancing device, CED, for retransmitting a signal via the CED. The CED is the CED disclosed herein, such as CED 600 of FIG. 1, CED 500 of FIG. 2 and/or CED 500A of FIGS. 4A-5.

In one or more example methods, the method 200 comprises receiving S102, by a first antenna port associated with at least one antenna element, a first signal. In one or more example methods, the method 200 comprises changing S104, by a phase changer, a phase of the first signal. In one or more example methods, the method 200 comprises changing, by a phase changer, a phase of the second signal. As discussed herein, the at least one antenna element may be an antenna and/or a portion of an antenna. The at least one antenna element may be an antenna patch. An antenna element may be an antenna element of an antenna array.

An antenna port, such as the first antenna port and/or the second antenna port, may be configured to receive and/or transmit a signal, such as the first signal and/or the first amplified signal. The second antenna port can be associated with the at least one antenna element. The first antenna port and/or the second antenna port may have a particular polarization.

The second antenna port can be different from the first antenna port, which can reduce self-oscillation. For example, by separating the second antenna port 22 from the first antenna port, coupling between receiving (Rx) and transmitting (Tx) signals can be reduced on a reflection surface of the coverage enhancing device, thereby avoiding self-oscillation, and allowing for reasonable amplification gain by amplifier.

In one or more example methods, the method 200 comprises amplifying S106, by an amplifier in communication with the first antenna port, the first signal for provision of a first amplified signal. In one or more example methods, the method 200 comprises transmitting S108, by a second antenna port in communication with the amplifier, the first amplified signal. In one or more example methods, the second antenna port is a different antenna port than the first antenna port.

An amplifier can be configured to amplify a signal, such as add gain to a signal.

In one or more example methods, the first antenna port forms at least a part of a first antenna element of the at least one antenna element and the second antenna port forms at least a part of the first antenna element.

In one or more example methods, the first antenna port forms at least a part of a first antenna element of the at least one antenna element and the second antenna port forms at least a part of a second antenna element of the at least one antenna element.

As an example, CED can be an antenna, such as an array of one or more antenna elements, such as an antenna array. In one or more example CEDs, an antenna element is a galvanic antenna unit and/or structure that may have one or two antenna ports. Two antenna ports can be connected to orthogonally polarized modes. An antenna port can be a feed point of an antenna element that is associated with one of the radiating modes, such as polarizations. A unit cell can be a group of one or more antenna elements that collectively fulfil a task, such as receive and retransmit a gain and/or phase shift. The antenna port may form a part of an antenna element can include being an antenna port associated with a particular antenna element. Forming a part of can be, for example, one or more of: part of, attached to, integral with, located on, and associated with.

In one or more example methods, the first antenna port has a different polarization than the second antenna port. For example, the first antenna port may have a vertical polarization and the second antenna port may have a horizontal polarization, and vice versa.

In one or more example methods, the method 200 comprises switching S110, by at least one switch connecting the first antenna port to the second antenna port, a direction of the communication between the first antenna port to the second antenna port from a first direction to a second direction opposite the first direction or from the second direction to the first direction. This can allow for both rank 1 and rank 2 transmissions. For example, the communication of the signal can flow in opposite directions, depending on the switch configuration.

In one or more example methods, switching S110 the direction comprises receiving S110A a switch configuration signal. In one or more example methods, switching S110 the direction comprises switching S110B, based on the switch configuration signal, the at least one switch to the first direction or the second direction. The switch configuration signal can be received by, for example, a network node such as network node 400 of FIG. 1.

In one or more example methods, the method 200 comprises receiving S112, by the second antenna port, a second signal. In one or more example methods, the method 200 comprises phase changing, via a phase changer, the second signal. In one or more example methods, the method 200 comprises amplifying S114, by the amplifier, the second signal for provision of a second amplified signal. In one or more example methods, the method 200 comprises transmitting S116, by the first antenna port, the second amplified signal.

In one or more example methods, the at least one antenna element comprises a plurality of first direction antenna elements each having a respective switch set to the first direction. In one or more example methods, the at least one antenna element comprises a plurality of second direction antenna elements each having a respective switch set to the second direction. In one or more example methods, a number of the plurality of first direction antenna elements is equal to a number of the plurality of second direction antenna elements.

In one or more example methods, amplifying S106, S114 comprises amplifying at a loop gain of below 1. This can prevent self-oscillation from occurring due to leakage of signal from a transmitting antenna port.

In one or more example methods, the coverage enhancing device is an active gain coverage enhancing device.

In one or more example methods, the at least one antenna element comprises a chain of antenna elements. In one or more example methods, the chain of antenna elements comprises a beginning antenna element, an ending antenna element, and a plurality of middle antenna elements. In one or more example methods, each antenna element of the chain of antenna elements has the first antenna port and the second antenna port. In one or more example methods, the method 200 comprises communicating S118 from each first antenna port of the plurality of middle antenna elements with the second antenna port of a different antenna element of the plurality of middle antenna elements. The chain of antenna elements can be similar to the chain of antenna elements shown in FIG. 4A, such as including the connectors 44, 54 of FIG. 4B and FIG. 4C.

Examples of methods and products (coverage enhancing device) according to the disclosure are set out in the following items:

Item 1. A coverage enhancing device comprising:
at least one antenna element;
a first antenna port associated with the at least one antenna element and configured to receive a first signal;
an amplifier in communication with the first antenna port, the amplifier configured to amplify the first signal for provision of a first amplified signal;
a second antenna port in communication with the amplifier, wherein the second antenna port is configured to transmit the first amplified signal;
wherein the second antenna port is a different antenna port than the first antenna port;
wherein the first antenna port forms at least a part of a first antenna element of the at least one antenna element and the second antenna port forms at least a part of a second antenna element of the at least one antenna element.

Item 2. A coverage enhancing device comprising:
at least one antenna element;
a first antenna port associated with the at least one antenna element and configured to receive a first signal;
an amplifier in communication with the first antenna port, the amplifier configured to amplify the first signal for provision of a first amplified signal;
a second antenna port in communication with the amplifier, wherein the second antenna port is configured to transmit the first amplified signal;
wherein the second antenna port is a different antenna port than the first antenna port.

Item 3. Coverage enhancing device of any of items 1-2, wherein the first antenna port forms at least a part of a first antenna element of the at least one antenna element and the second antenna port forms at least a part of the first antenna element.

Item 4. Coverage enhancing device of item 2, wherein the first antenna port forms at least a part of a first antenna element of the at least one antenna element and the second antenna port forms at least a part of a second antenna element of the at least one antenna element.

Item 5. Coverage enhancing device of any one of the previous items, wherein the first antenna port has a different polarization than the second antenna port.

Item 6. Coverage enhancing device of any one of the previous items, wherein:
the second antenna port is configured to receive a second signal;
the amplifier is configured to amplify the second signal for provision of a second amplified signal; and
the first antenna port is configured to transmit the second amplified signal.

Item 7. Coverage enhancing device of item 6, wherein the coverage enhancing device comprises at least one switch in communication with the first antenna port to the second antenna port, wherein the at least one switch is configured to provide, in a first position, a connection in a first direction from the first antenna port to the second antenna port and, in a second position, a connection in a second direction from the second antenna port to the first antenna port.

Item 8. Coverage enhancing device of item 7, wherein the coverage enhancing device is configured to receive a switch configuration signal and, based on the switch configuration signal, to set the at least one switch in the first position or the second position.

Item 9. Coverage enhancing device of items 7 or 8, wherein the at least one antenna element comprises a plurality of first direction antenna elements each having a respective switch set to the first position, and a plurality of second direction antenna elements each having a respective switch set to the second position, wherein a number of the plurality of first direction antenna elements is equal to a number of the plurality of second direction antenna elements.

Item 10. Coverage enhancing device of any one of the previous items, wherein the coverage enhancing device is configured to amplify the first signal at a loop gain of below 1.

Item 11. Coverage enhancing device of any one of the previous items, wherein the coverage enhancing device further comprises a phase changer configured to change the phase of the first signal.

Item 12. Coverage enhancing device of any one of the previous items, wherein the coverage enhancing device is an active gain coverage enhancing device.

Item 13. Coverage enhancing device of any one of the previous items, wherein:
the at least one antenna element comprises a chain of antenna elements comprising a beginning antenna element, an ending antenna element, and a plurality of middle antenna elements;
each antenna element of the chain of antenna elements having respective first antenna ports and respective second antenna ports; and
each first antenna port of the plurality of middle antenna elements is in communication, via a respective amplifier, with the second antenna port of a different antenna element of the plurality of middle antenna elements.

Item 14. A method of retransmitting a signal via a coverage enhancing device, the method comprising:
receiving, by a first antenna port associated with at least one antenna element, a first signal;
amplifying, by an amplifier in communication with the first antenna port, the first signal for provision of a first amplified signal; and
transmitting, by a second antenna port in communication with the amplifier, the first amplified signal;
wherein the second antenna port is a different antenna port than the first antenna port.

Item 15. Method of item 14, wherein the first antenna port forms at least a part of a first antenna element of the at least one antenna element and the second antenna port forms at least a part of the first antenna element.

Item 16. Method of item 14, wherein the first antenna port forms at least a part of a first antenna element of the at least one antenna element and the second antenna port forms at least a part of a second antenna element of the at least one antenna element.

Item 17. Method of any one of items 14-16, wherein the first antenna port has a different polarization than the second antenna port.

Item 18. Method of any one of items 14-17, further comprising:
receiving, by the second antenna port, a second signal;
amplifying, by the amplifier, the second signal for provision of a second amplified signal; and
transmitting, by the first antenna port, the second amplified signal.

Item 19. Method of item 18, further comprising:
switching, by at least one switch in communication with the first antenna port to the second antenna port, a direction of the communication between the first antenna port to the second antenna port from a first direction to a second direction opposite the first direction or from the second direction to the first direction.

Item 20. Method of item 19, wherein switching the direction comprises:
receiving a switch configuration signal; and
switching, based on the switch configuration signal, the at least one switch to the first direction or the second direction.

Item 21. Method of item 19 or 20, wherein the at least one antenna element comprises a plurality of first direction antenna elements each having a respective switch set to the first direction, and a plurality of second direction antenna elements each having a respective switch set to the second direction, wherein a number of the plurality of first direction antenna elements is equal to a number of the plurality of second direction antenna elements.

Item 22. Method of any one of items 14-21, wherein amplifying comprises amplifying at a loop gain of below 1.

Item 23. Method of any one of items 14-22, further comprising:
changing, by a phase changer, a phase of the first signal.

Item 24. Method of any one of items 14-23, wherein the coverage enhancing device is an active gain coverage enhancing device.

Item 25. Method of any one of items 14-24, wherein:
the at least one antenna element comprises a chain of antenna elements comprising a beginning antenna element, an ending antenna element, and a plurality of middle antenna elements;
each antenna element of the chain of antenna elements having respective first antenna ports and respective second antenna ports; and
the method further comprises communicating from each first antenna port of the plurality of middle antenna elements with the second antenna port of a different antenna element of the plurality of middle antenna elements.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A coverage enhancing device comprising:
at least one antenna element;
a first antenna port associated with the at least one antenna element and configured to receive a first signal;
an amplifier in communication with the first antenna port, the amplifier configured to amplify the first signal for provision of a first amplified signal;
a second antenna port in communication with the amplifier, wherein the second antenna port is configured to transmit the first amplified signal;
wherein the second antenna port is a different antenna port than the first antenna port;
wherein the first antenna port forms at least a part of a first antenna element of the at least one antenna element and the second antenna port forms at least a part of a second antenna element of the at least one antenna element.

2. The coverage enhancing device of claim 1, wherein the first antenna port forms at least a part of a first antenna element of the at least one antenna element and the second antenna port forms at least a part of the first antenna element.

3. The coverage enhancing device of claim 1, wherein the first antenna port has a different polarization than the second antenna port.

4. The coverage enhancing device of claim 1, wherein:
the second antenna port is configured to receive a second signal;
the amplifier is configured to amplify the second signal for provision of a second amplified signal; and
the first antenna port is configured to transmit the second amplified signal.

5. The coverage enhancing device of claim 4, wherein the coverage enhancing device comprises at least one switch in communication with the first antenna port to the second antenna port, wherein the at least one switch is configured to provide, in a first position, a connection in a first direction from the first antenna port to the second antenna port and, in a second position, a connection in a second direction from the second antenna port to the first antenna port.

6. The coverage enhancing device of claim 5, wherein the coverage enhancing device is configured to receive a switch configuration signal and, based on the switch configuration signal, to set the at least one switch in the first position or the second position.

7. The coverage enhancing device of claim 5, wherein the at least one antenna element comprises a plurality of first direction antenna elements each having a respective switch set to the first position, and a plurality of second direction antenna elements each having a respective switch set to the second position, wherein a number of the plurality of first direction antenna elements is equal to a number of the plurality of second direction antenna elements.

8. The coverage enhancing device of claim 1, wherein the coverage enhancing device is configured to amplify the first signal at a loop gain of below 1.

9. The coverage enhancing device of claim 1, wherein the coverage enhancing device further comprises a phase changer configured to change the phase of the first signal.

10. The coverage enhancing device of claim 1, wherein the coverage enhancing device is an active gain coverage enhancing device.

11. The coverage enhancing device of claim 1, wherein:
the at least one antenna element comprises a chain of antenna elements comprising a beginning antenna element, an ending antenna element, and a plurality of middle antenna elements;
each antenna element of the chain of antenna elements having respective first antenna ports and respective second antenna ports; and
each first antenna port of the plurality of middle antenna elements is in communication, via a respective amplifier, with the second antenna port of a different antenna element of the plurality of middle antenna elements.

12. A method of retransmitting a signal via a coverage enhancing device, the method comprising:
receiving, by a first antenna port associated with at least one antenna element, a first signal;
amplifying, by an amplifier in communication with the first antenna port, the first signal for provision of a first amplified signal; and
transmitting, by a second antenna port in communication with the amplifier, the first amplified signal;
wherein the second antenna port is a different antenna port than the first antenna port;
wherein the first antenna port forms at least a part of a first antenna element of the at least one antenna element and the second antenna port forms at least a part of a second antenna element of the at least one antenna element.

13. The method of claim 12, wherein the first antenna port forms at least a part of a first antenna element of the at least one antenna element and the second antenna port forms at least a part of the first antenna element.

14. The method of claim 12, wherein the first antenna port has a different polarization than the second antenna port.

15. The method of claim 12, further comprising:
receiving, by the second antenna port, a second signal;
amplifying, by the amplifier, the second signal for provision of a second amplified signal; and
transmitting, by the first antenna port, the second amplified signal.

16. The method of claim 15, further comprising:
switching, by at least one switch in communication with the first antenna port to the second antenna port, a direction of the communication between the first antenna port to the second antenna port from a first direction to a second direction opposite the first direction or from the second direction to the first direction.

17. The method of claim 16, wherein switching the direction comprises:
receiving a switch configuration signal; and
switching, based on the switch configuration signal, the at least one switch to the first direction or the second direction.

18. The method of claim 16, wherein the at least one antenna element comprises a plurality of first direction antenna elements each having a respective switch set to the first direction, and a plurality of second direction antenna elements each having a respective switch set to the second direction, wherein a number of the plurality of first direction antenna elements is equal to a number of the plurality of second direction antenna elements.

19. The method of claim 12, wherein amplifying comprises amplifying at a loop gain of below 1.

20. The method of claim 12, further comprising: changing, by a phase changer, a phase of the first signal.

21-22. (canceled)
